(19) United States
(12) Patent Application Publication
(10) Pub. No.: US 2026/0184278 A1
(43) Pub. Date: Jul. 2, 2026

(54) Operating Communication Device Based on Detected Vehicle Occupants

(71) Applicant: MOTOROLA SOLUTIONS, INC., CHICAGO, IL (US)

(72) Inventors: ELLIS A. PINDER, DAVIE, FL (US); KIESHA GRANT, PLANTATION, FL (US)

(21) Appl. No.: 19/004,821

(22) Filed: Dec. 30, 2024

(51) Int. Cl. B60R 16/037; B60K 35/10; G10L 15/22; G10L 17/22

(52) U.S. Cl. CPC B60R 16/0373; B60K 35/10; G10L 15/22; G10L 17/22; G10L 2015/223

(57) ABSTRACT

An electronic digital assistant of a computing device is automatically modified in an in-vehicle setting to prevent unauthorized users co-located in the vehicle from issuing sensitive voice commands to the electronic digital assistant. The computing device receives sensor data indicating an occupancy status of one or more seating zones in the vehicle and determines, based on the sensor data, that a particular seating zone in the vehicle is occupied. When the electronic digital assistant receives a voice command while the particular seating zone is occupied, the voice command is evaluated to determine whether it is a sensitive voice command. When the voice command is a sensitive command, the electronic digital assistant refrains from executing the command until an authorized user provides authorization by way of a physical user input. When the voice command is not a sensitive voice command, the electronic digital assistant executes the command without further authorization.

### BACKGROUND OF THE INVENTION

Tablets, laptops, phones (e.g., cellular or satellite), mobile (vehicular) or portable (personal) two-way radios, and other computing devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such computing devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as the SIRI® assistant provided by Apple, Inc. and the GOOGLE® assistant provided by Google, Inc., are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a system for operating an electronic digital assistant, according to some examples.

FIG. 2 illustrates a schematic diagram of an electronic computing device for operating an electronic digital assistant, according to some examples.

FIG. 3 illustrates a flowchart of a process for operating an electronic digital assistant, according to some examples.

FIG. 4 illustrates seating zones of a vehicle for use in operating an electronic digital assistant, according to some examples.

FIG. 5 illustrates aspects of voice control dictionaries for use in operating an electronic digital assistant, according to some examples.

FIG. 6 illustrates a flowchart of another process for operating an electronic digital assistant, according to some examples.

FIG. 7 illustrates a user interface of an electronic computing device for operating an electronic digital assistant, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION OF THE INVENTION

In many cases, an electronic digital assistant may receive a voice command, process the voice command to identify a corresponding task to the voice command, and cause a computing device to perform the task. However, a problem exists in that some environments in which the user may operate the computing device are not as amenable to receiving and processing certain voice commands as other environments. For example, in public safety environments, the electronic digital assistant may be capable of causing the computing device to perform public safety related tasks in response to receiving a voice command from a public safety officer. Such tasks may involve causing the computing device to produce an auditory output of sensitive information, such as the status of a public safety officer or an active emergency incident, or causing the computing device to transmit sensitive information to another computing device, such as that of another public safety officer or a dispatcher. Using an electronic digital assistant in such a manner could be problematic if the individual issuing the corresponding voice commands is not an authorized user. For example, it would not be desirable for a suspect in custody to issue a voice command to a public safety officer's computing device to obtain information about an incident involving the suspect or an officer investigating the suspect or to request dispatching services in connection with the incident. Accordingly, the electronic digital assistant should be configured to perform tasks corresponding to certain sensitive voice commands only when those commands are issued by an authorized user.

One way to verify that the voice command issuer is an authorized user is by using biometrics. However, biometric verification can have various drawbacks. For instance, some biometrics, such as fingerprint or facial recognition biometrics, require physical interaction with the computing device. But requiring such physical interaction in order to verify every voice command can become cumbersome, particularly when the computing device is not readily accessible or when the authorized user is predisposed with another task. For public safety officers, such situations may arise when an officer is driving a vehicle, and physically interacting with the computing device would require the officer to remove their hand(s) from the wheel and/or take their eyes off the road, which could result in a hazardous driving scenario, such as when the computing device takes the form of a vehicular radio or infotainment system that diverts the officer's attention from the road, or when the computing device is difficult to physically access, such as when the computing device takes the form of a radio device secured on the officer's belt clip, causing the device to be wedged into the driver's seat.

Thus, there exists a need for an improved technical method, device, and system for modifying the functionality of an electronic computing device to prevent an electronic digital assistant from processing sensitive voice commands when the computing device is in the presence of an unauthorized user. Namely, the present disclosure provides such improved solutions for scenarios similar to those described above, such as when the computing device is in a vehicle transporting one or more unauthorized users of the computing device.

One example provides a method comprising: (i) providing a user interface for receiving a physical user input and an electronic digital assistant configured to receive a set of voice commands, the set of voice commands comprising a first subset of voice commands and a second subset of voice commands; (ii) receiving, by the electronic digital assistant, a voice command; (iii) determining, by the electronic digital assistant, whether the received voice command is included in the first subset of voice commands or the second subset of voice commands; (iv) receiving, from at least one occupancy sensor, sensor data indicating an occupancy status of one or more seating zones in a vehicle; (v) determining, based on the sensor data, that a particular seating zone of the one or more seating zones in the vehicle is occupied; and (vi) in response to both receiving the voice command and determining that the particular seating zone is occupied, performing a voice command verification process comprising (a) when the received voice command is included in the first subset of voice commands, causing the electronic digital assistant to refrain from executing the voice command until the user interface receives the physical user input, and (b) when the received voice command is included in the second subset of voice commands, causing the electronic digital assistant to substantially immediately execute the voice command.

In some aspects of the method, the set of voice commands comprises voice commands for interfacing with a public safety computing system, and wherein the first subset of voice commands comprises at least one of (i) an incident status query, (ii) an officer status query, (iii) a radio access command, or (iv) a dispatcher access command.

In some aspects of the method, the user interface comprises a foot switch arranged in a footwell of the vehicle, and the physical user input comprises an actuation of the foot switch.

In some aspects of the method, the particular seating zone comprises a rear seat zone located in a rear seating area of the vehicle.

In some aspects of the method, the method further comprises: (i) receiving vehicle data indicating a type of the vehicle; and (ii) defining the one or more seating zones based on the type of the vehicle. Further, in some of these aspects, the method further comprises determining a seating configuration of the vehicle based on the type of the vehicle, wherein defining the one or more seating zones based on the type of the vehicle comprises defining the one or more seating zones based on the determined seating configuration of the vehicle. Still further, in some of these aspects, the vehicle data indicates that the type of the vehicle is that of a vehicle comprising a physical barrier separating a rear seating area of the vehicle from a front seating area of the vehicle, and defining the one or more seating zones based on the type of the vehicle comprises defining the one or more seating zones to include at least a portion of the rear seating area based on the vehicle comprising the physical barrier.

Another example provides an electronic computing device comprising: (i) a user interface for receiving a physical user input; (ii) an electronic digital assistant configured to receive a set of voice commands, the set of voice commands comprising a first subset of voice commands and a second subset of voice commands; (iii) at least one processor; and (iv) non-transitory computer-readable data storage comprising program instructions that, when executed by the at least one processor, cause the electronic computing device to perform any or all aspects of the example method described above.

Still another example provides a system comprising: (i) an electronic computing device comprising a user interface for receiving a physical user input and an electronic digital assistant configured to receive a set of voice commands, the set of voice commands comprising a first subset of voice commands and a second subset of voice commands; (ii) at least one occupancy sensor configured to output sensor data indicating an occupancy status of one or more seating zones in a vehicle; (iii) at least one processor; and (iv) non-transitory, computer-readable data storage comprising program instructions that, when executed by the at least one processor, cause the system to perform any or all aspects of the example method described above.

Each of the above-mentioned examples will be discussed in more detail below, starting with example system and device architectures of the system in which the examples may be practiced, followed by an illustration of processing blocks for achieving an improved technical method, device, and system for modifying the functionality of a communication device to prevent an electronic digital assistant from processing sensitive voice commands when the communication device is in the presence of an unauthorized user.

Examples are herein described with reference to flowchart illustrations and/or block diagrams of methods, apparatus (systems and devices), and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the operations specified in the flowchart and/or block diagram block or blocks. The methods and processes set forth herein need not, in some examples, be performed in the exact sequence as shown and, where possible, various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

### 1. Communication System and Device Structures

a. Communication System Structure

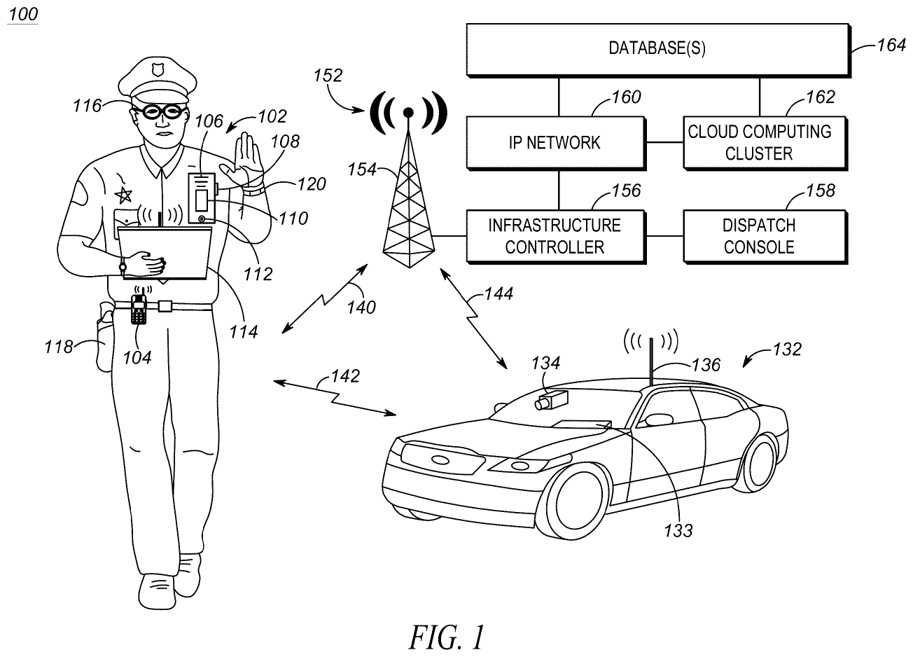

Referring now to the drawings, and in particular FIG. 1, a communication system diagram illustrates a system 100 of devices including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices (wherein the single user 102 and the additional users may form a talkgroup of related users).

System 100 may also include a vehicle 132 associated with the user 102 having an integrated mobile communication device 133, an associated vehicular video camera 134, and a coupled vehicular transceiver 136. Although FIG. 1 illustrates only a single vehicle 132 with a single mobile communication device 133, respective single vehicular video camera 134 and/or microphone 135, single coupled vehicular transceiver 136, and single speaker 137, in other embodiments, the vehicle 132 may include additional same or similar mobile communication devices, video cameras, microphones, speakers, and/or transceivers, and additional vehicles may be present with respective additional sets of mobile communication devices, video cameras, speakers, microphones, and/or transceivers.

Each of the portable radio 104, RSM video capture device 106, laptop 114, and vehicular mobile communication device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits. These devices may be referred to as communication devices and are configured to receive inputs associated with the user 102 and/or provide outputs to the user 102 in addition to communicating information to and from other communication devices and the infrastructure RAN 152.

The portable radio 104, in particular, may be any communication device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (i.e., long-range in comparison to a short-range transmitter such as a Bluetooth, Zigbee, or NFC transmitter) with other communication devices and/or the infrastructure RAN 152. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a USB port, an Ethernet port, an audio jack, etc.) for direct electronic coupling with the RSM video capture device 106, laptop 114, and/or smart glasses 116. In some embodiments, the portable radio 104 may contain a short-range transmitter (i.e., short-range in comparison to the long-range transmitter such as a LMR or broadband transmitter) and/or transceiver for wirelessly coupling with the RSM video capture device 106, laptop 114, and/or smart glasses 116. The short-range transmitter may be a Bluetooth, Zigbee, or NFC transmitter having a transmit range on the order of 0.01-100 meters, or 0.1-10 meters. In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the user's 102 mouth, providing a remote speaker allowing playback of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or to the infrastructure RAN 152. The voice and/or audio played back at the remote speaker may be received from the portable radio 104 or received directly from one or more other communication devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single communication device to communicate with one or more group members (i.e., talkgroup members not shown in FIG. 1) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a field-of-view associated with the user, perhaps including a suspect and the suspect's surroundings, storing the captured image and/or audio data for further analysis or transmitting the captured audio and/or video data as an audio and/or vide stream to the portable radio 104 and/or to other communication devices or to the infrastructure RAN 152 directly for further analysis. An RSM remote microphone of the RSM video capture device 106 may be an omni-directional or unidirectional microphone or array of omni-directional or unidirectional microphones that may be capable of identifying a direction from which a captured sound emanated.

In some embodiments, the RSM video capture device 106 may be replaced with a more limited body worn camera that may include the video camera 112 and/or microphone noted above for capturing audio and/or video, but may forego one or more of the features noted above that transform the body worn camera into a more full featured RSM, such as the separate physical PTT switch 108 and the display screen 110, remote microphone functionality for voice communications in cooperation with portable radio 104, and remote speaker.

The laptop 114 may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, and/or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, perhaps including a field-of-view of the user 102 and/or a suspect (or potential suspect) and the suspect's surroundings, and store and/or otherwise process the captured video and/or audio for further analysis or transmit the captured video and/or audio as a video and/or audio stream to the portable radio 104, other communication devices, and/or the infrastructure RAN 152 for further analysis.

An in-ear or over-the ear earpiece or headphone may be present for providing audio to the user in a private fashion that is not accessible to other users nearby the user 102. The earpiece or headphone may be wiredly or wirelessly communicatively coupled to one or both of the RSM 106 and the portable radio 104, which may be configured to provide audio received from the RAN 152 and/or from other users to the user 102 based on a manual configuration of the RSM 106 or the portable radio 104, or based on some automatic routing mechanism at the one of the RSM 106 and the portable radio 104 that may route all audio to the earpiece or headphone whenever it is detected as connected to the one of the RSM 106 and the portable radio 104, or may selectively route audio received at the one of the RSM 106 and the portable radio 104 to the earpiece or headphone based on various contextual parameters, such as a content of the received audio, an identity of who sent the received audio, a covert status of the user 102, an incident status of the user 102, a determination of nearby users associated with the user 102, or some other contextual parameter.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In other embodiments, an additional user interface mechanism such as a touch interface or gesture detection mechanism may be provided at the smart glasses 116 that allows the user 102 to interact with the display elements displayed on the smart glasses 116 or projected into the user's 102 eyes, or to modify operation of the digital imaging device. In still other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact. In some embodiments, the smart glasses 116 may provide an augmented reality interface in which a direct or indirect view of real-world environments in which the user is currently disposed are augmented (i.e., supplemented, by additional computer-generated sensory input such as sound, video, images, graphics, GPS data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiography (EKG) signal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, or other short-range wireless protocol having a transmission range on the order of meters, tens of meters, or hundreds of meters.

The portable radio 104 and/or RSM video capture device 106 (or any other electronic device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 152.

The vehicle 132 associated with the user 102 may include the mobile communication device 133, the vehicular video camera 134 and/or microphone 135, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other communication devices, and/or the infrastructure RAN 152 for further analysis. The omni-directional or unidirectional microphone 135, or an array thereof, may be integrated in the video camera 134 and/or at the vehicular computing device 133 (or additionally or alternatively made available at a separate location of the vehicle 132) and communicably coupled to the vehicular computing device 133 and/or vehicular transceiver 136 for capturing audio and storing, processing, and/or transmitting the audio in a same or similar manner as set forth above with respect to the RSM 106.

Although FIG. 1 illustrates the vehicular video camera 134 and microphone 135 as being placed inside the vehicle 132, in other embodiments, one or both of the vehicular video camera 134 and microphone 135 may be placed at visible or hidden locations outside of the vehicle 132, such as within a vehicular grill portion or bumper portion, or on a roof portion, of the vehicle 132. Further, although FIG. 1 illustrates the single speaker 137 as being placed inside of the vehicle 132 and coupled to the vehicular computing device 133, in other embodiments, multiple speakers may be provided inside and/or outside of the vehicle 132 (all addressed simultaneously or individually addressable for outputting separate audio streams), or the single speaker 137 may be placed outside of the vehicle and function as a PA speaker, among other possibilities.

The vehicle 132 may be a human-operable vehicle, or may be a self-driving vehicle operable under control of mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or transceiver 136, similar to the portable radio 104 and/or respective receivers, transmitters, or transceivers thereof, may include a location (and/or orientation) determination device integrated with or separately disposed in the mobile communication device 133 and/or transceiver 136 for determining (and storing and/or transmitting) a location (and/or orientation) of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras and sensors) within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, interior-facing cameras, or other types of audio and/or video recording devices accessible via a wired or wireless network interface same or similar to that disclosed herein.

Infrastructure RAN 152 is a radio access network that provides for radio communication links to be arranged within the network between a plurality of user terminals. Such user terminals may be portable, mobile, or stationary and may include any one or more of the communication devices illustrated in FIG. 1, among other possibilities. At least one other terminal, e.g. used in conjunction with the communication devices, may be a fixed terminal, e.g. a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site,’ by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated as narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless application, enables familiar PTT and “instant on” features of traditional half duplex communication devices, but uses communication devices operating over modern broadband telecommunications networks. Using OMA-PoC, wireless communication devices such as mobile telephones and notebook computers can function as PTT half-duplex communication devices for transmitting and receiving. Other types of PTT models and multimedia call models (MMCMs) are also available.

Floor control in an OMA-PoC session is generally maintained by a PTT server that controls communications between two or more wireless communication devices. When a user of one of the communication devices keys a PTT button, a request for permission to speak in the OMA-PoC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency or frequency & time slot (in which case, in some embodiments, group IDs may be present in the group data to distinguish between groups).

In contrast, a trunked radio system and its communication devices use a pool of traffic channels for virtually an unlimited number of groups of communication devices (and which may also be referred to herein as talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster such as cloud compute cluster 162 communicably coupled to controller 156 via internet protocol (IP) network 160, among other possibilities.

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single infrastructure controller 156 (e.g., a radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices.

The infrastructure controller 156 illustrated in FIG. 1, or some other back-end infrastructure device or combination of back-end infrastructure devices existing on-premises or in the remote cloud compute cluster 162 accessible via the IP network 160 (such as the Internet), may additionally or alternatively operate as a back-end electronic digital assistant, a back-end audio and/or video processing device, and/or a remote cloud-based storage device consistent with the remainder of this disclosure.

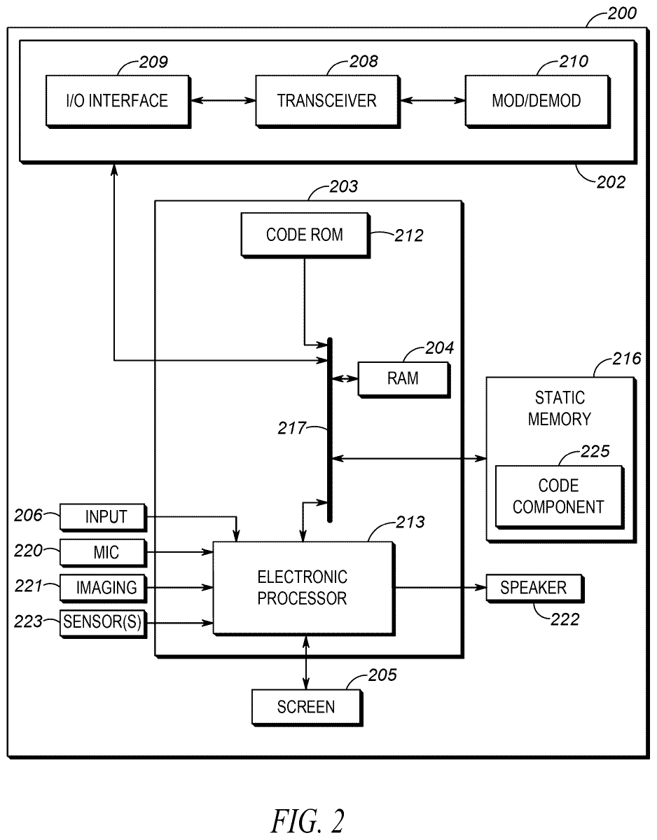

The IP network 160 may comprise one or more routers, switches, LANs, WLANs, WANs, access points, or other network infrastructure, including but not limited to, the public Internet. The cloud compute cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud compute cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

Database(s) 164 may be accessible via IP network 160 and/or cloud compute cluster 162, and may include databases such as a long-term video storage database, a historical or forecasted weather database, an offender database perhaps including facial recognition images to match against, a cartographic database of streets and elevations, a traffic database of historical or current traffic conditions, or other types of databases. Databases 164 may further include all or a portion of the databases described herein as being provided at infrastructure controller 156. In some embodiments, the databases 164 may be maintained by third parties (for example, the National Weather Service or a Department of Transportation, respectively). As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The databases 164 of FIG. 1 are merely examples. In some embodiments, the system 100 additionally or alternatively includes other databases that store different information. In some embodiments, the databases 164 disclosed herein and/or additional or other databases are integrated with, or internal to, the infrastructure controller 156.

Finally, although FIG. 1 describes a communication system 100 generally as a public safety communication system that includes a user 102 generally described as a police officer and a vehicle 132 generally described as a police car or cruiser, in other embodiments, the communication system 100 may additionally or alternatively be a retail communication system including a user 102 that may be an employee of a retailer and a vehicle 132 that may be a vehicle for use by the user 102 in furtherance of the employee's retail duties (e.g., a shuttle or self-balancing scooter). In other embodiments, the communication system 100 may additionally or alternatively be a warehouse communication system including a user 102 that may be an employee of a warehouse and a vehicle 132 that may be a vehicle for use by the user 102 in furtherance of the employee's retail duties (e.g., a forklift). In still further embodiments, the communication system 100 may additionally or alternatively be a private security communication system including a user 102 that may be an employee of a private security company and a vehicle 132 that may be a vehicle for use by the user 102 in furtherance of the private security employee's duties (e.g., a private security vehicle or motorcycle). In even further embodiments, the communication system 100 may additionally or alternatively be a medical communication system including a user 102 that may be a doctor or nurse of a hospital and a vehicle 132 that may be a vehicle for use by the user 102 in furtherance of the doctor or nurse's duties (e.g., a medical gurney or ambulance). In still another example embodiment, the communication system 100 may additionally or alternatively be a heavy machinery communication system including a user 102 that may be a miner, driller, or extractor at a mine, oil field, or precious metal or gem field and a vehicle 132 that may be a vehicle for use by the user 102 in furtherance of the miner, driller, or extractor's duties (e.g., an excavator, bulldozer, crane, front loader). As one other example, the communication system 100 may additionally or alternatively be a transportation logistics communication system including a user 102 that may be a bus driver or semi-truck driver at a school or transportation company and a vehicle 132 that may be a vehicle for use by the user 102 in furtherance of the driver's duties. In the examples of a user 102 being other than a police officer, certain sensors such as the weapon status sensor described above with respect to the police officer user may be replaced or supplemented with other types of sensors, such as one or more sensors that may detect whether a particular retail, warehouse, private security, heavy machinery operator, transportation driver, or other type of user has equipment necessary to perform a particular assigned or to-be-assigned task, whether such equipment is in a workable or sufficient condition, or whether the equipment is sufficient for the area or environment the user is in. Other possibilities and other variations exist as well.

b. Device Structure

FIG. 2 sets forth a schematic diagram that illustrates an electronic communication device 200 according to some embodiments of the present disclosure. The communication device 200 may be, for example, embodied in the portable radio 104, the RSM video capture device 106, the laptop 114, the mobile communication device 133, the infrastructure controller 156, the dispatch console 158, one or more computing devices in the cloud compute cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the communication device 200 (for example, the portable radio 104) may be communicatively coupled to other devices such as the mobile communication device 133 as described above. In such embodiments, the combination of the portable radio 104 and the mobile communication device 133 may be considered a single communication device 200.

While FIG. 2 represents the communication devices described above with respect to FIG. 1, depending on the type of the communication device, the communication device 200 may include fewer or additional components in configurations different from that illustrated in FIG. 2. For example, in some embodiments, communication device 200 acting as the infrastructure controller 156 may not include one or more of the screen 205, input device 206, microphone 220, imaging device 221, speaker 222, and sensors 223. As another example, in some embodiments, the communication device 200 acting as the portable radio 104, the mobile communication device 133, or the RSM video capture device 106 may further include a location determination device (for example, a global positioning system (GPS) receiver) as explained above. Other combinations are possible as well.

As shown in FIG. 2, communication device 200 includes a communications unit 202 coupled to a common data and address bus 217 of a processing unit 203. The communication device 200 may also include one or more input devices (e.g., keypad, pointing device, touch-sensitive surface, etc.) 206 and an electronic display screen 205 (which, in some embodiments, may be a touch screen and thus also act as an input device 206), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of the communication device 200 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The communication device 200 may further include one or more sensors 223 (e.g., including any of the sensors described above in connection with FIG. 1) communicatively coupled (e.g., via wired or wireless communication links) to the processing unit 203 for providing sensor data that is processed by processing unit 203 in accordance with the remainder of this disclosure. The sensors 223 may include one or more occupancy sensors configured to output sensor data indicating an occupancy status of the vehicle 132. Such occupancy sensors may take various forms. In some examples, the occupancy sensors may include pressure or weight sensors (e.g., piezoresistive, capacitive, or strain gauge sensors) disposed within the seats of the vehicle 132. For instance, any or all of the vehicle seats may include one or more pressure or weight sensors that output an electrical signal that varies based on the pressure or weight applied to the seat. The output signal may be a binary signal (e.g., a 0 or 1) representing an occupied status of the seat (i.e., unoccupied or occupied), the value of which depends on whether the pressure or weight applied to the seat exceeds a threshold pressure or weight, or the output signal may be a continuous signal (e.g., proportional to the applied pressure or weight), which the processing unit 203 may receive and use to determine whether the seat is occupied. In some examples, the occupancy sensors may include motion or object detection sensors, such as millimeter wave (mmWave) sensors or infrared (IR) sensors. These sensors output an electromagnetic signal (e.g., a signal in the millimeter band for mmWave sensors or in the IR band for IR sensors) and receive reflections of the output signal. When a person or object interferes with the electromagnetic signal, such as by sitting in one of the vehicle seats, the sensor detects changes in the reflected signal caused by the interference and responsively outputs a signal indicating that the seat is occupied. Still further, in some examples, the occupancy sensors may include a camera configured to capture video or images of the cabin of the vehicle 132. The processing unit 203 may then apply one or more computer vision algorithms to the captured video or images to determine whether a respective seat of the vehicle 132 is occupied. The occupancy sensors may additionally or alternatively include any other sensors now known or later developed capable of detecting whether a respective seat of the vehicle 132 is occupied.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless RAN 152, and/or the mobile communication device 133.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

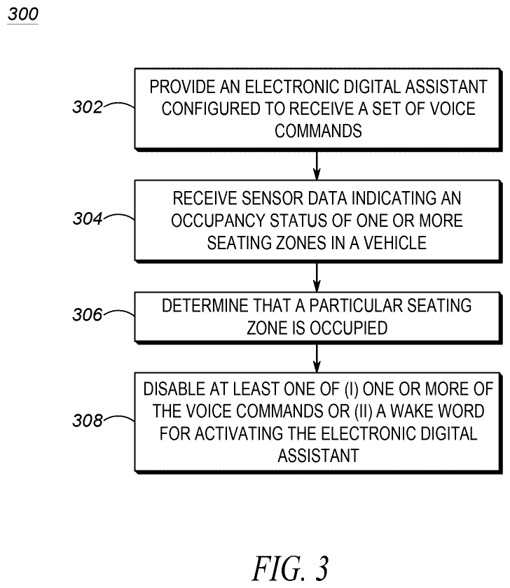

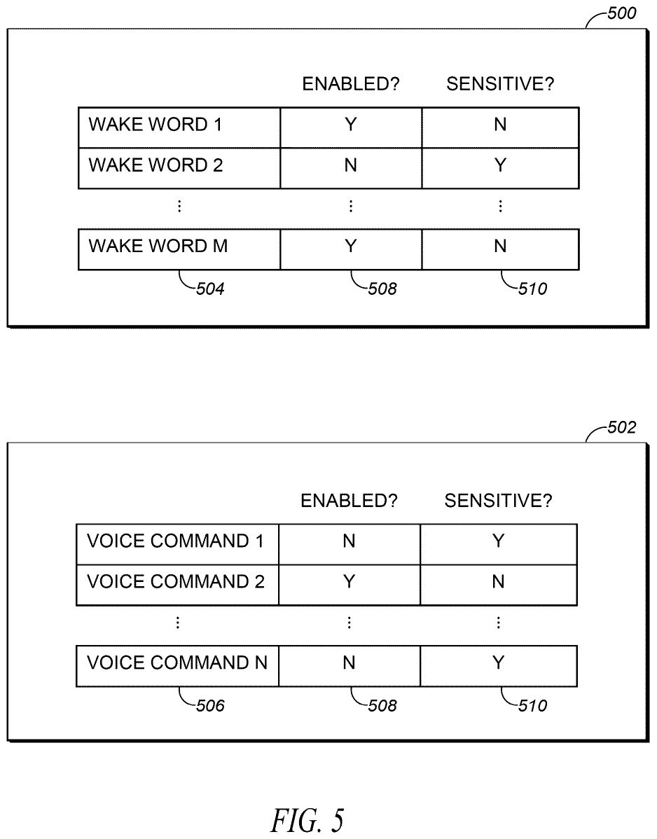

The electronic processor 213 has ports for coupling to the display screen 205, the input device 206, the microphone 220, the imaging device 221, and/or the speaker 222. The static memory 216 may store operating code 225 for the electronic processor 213 that, when executed, performs one or more of the steps set forth in FIG. 3, FIG. 5, and their accompanying text.

In some embodiments, the static memory 216 may also store, permanently or temporarily, one or more voice control dictionaries comprised of voice control keywords along with matching audio or voice tokens for each keyword, such tokens including, for example, digital audio for pattern matching, parameters of audio for feature analysis comparison, and/or trained neural network models or classifiers for corresponding voice keywords, among other possibilities.

The static memory 216 may comprise, for example, a hard-disk drive (HDD), an optical disk drive such as a compact disk (CD) drive or digital versatile disk (DVD) drive, a solid state drive (SSD), a flash memory drive, or a tape drive, and the like.

### 2. Processes for Modifying the Functionality of a Communication Device to Prevent an Electronic Digital Assistant from Processing Sensitive Voice Commands When the Communication Device is in the Presence of an Unauthorized User

In some embodiments, an individual component and/or a combination of individual components of the system 100 may be referred to as an electronic computing device that implements an electronic digital assistant as mentioned above. For example, the electronic computing device may be a single electronic processor (for example, the electronic processor 213 of the portable radio 104). In other embodiments, the electronic computing device includes multiple electronic processors distributed remotely from each other. For example, the electronic computing device may be implemented on a combination of at least two of the electronic processor 213 of the portable radio 104, the electronic processor 213 of the mobile communication device 133, the electronic processor 213 of the infrastructure controller 156, or the electronic processor 213 of a back-end cloud compute cluster 162 accessible via the IP network 160.

To use the electronic digital assistant implemented by the electronic computing device, the user 102 may, for example, provide an oral query or statement that is received by the microphone 220 of the communication device 200. The electronic computing device receives signals representative of the oral query or statement from the microphone 220 and analyzes the signals to determine the content of the oral query or statement. For example, the electronic computing device may include a natural language processing (NLP) engine configured to determine the intent and/or content of the oral query or statement. The electronic computing device may also be configured to determine a response to the oral query (for example, by retrieving stored data from the static memory 216 or by requesting data from a database such as one of the databases 164) and provide the response to an output device of the communication device 200 (for example, one or more of the speaker 222 via a generated audio response and the screen 205 via a generated text based response), or some other action to take in light of the content of the oral query and/or statement. In other words, one or more of the communication device 200, embodied in one or more of the communication devices of FIG. 1, such as the portable radio 104, the mobile communication device 133, the infrastructure controller 156, and/or the cloud compute cluster 162, may include an NLP engine to analyze oral queries and/or statements received by the microphone 220 of the communication device 200 and provide responses to the oral queries and/or take other actions in response to the oral statements.

The oral query or statement may take various forms and, in some examples, may include an activation keyword or phrase, often referred to as a “wake word,” followed by a substantive command or request indicative of a task the user wishes the electronic digital assistant to perform, referred to herein as a “voice command.” In such scenarios, the electronic computing device may continuously or periodically “listen” for a wake word before activating other electronic digital assistant functionalities. For instance, the electronic computing device may receive ambient audio signals captured by the microphone 220 and process the audio signals (e.g., using the NLP engine) to determine whether the captured audio signals include a wake word. This may involve comparing the captured audio signals to one or more voice control dictionaries stored in the static memory 216 to match at least a portion of the audio signals to one or more audio or voice tokens corresponding to the wake word.

When the electronic computing device is unable to detect the wake word in the captured audio signals (e.g., by failing to match the captured audio signals to one or more wake word voice tokens in the voice control dictionaries), the electronic computing device continues to “listen” for the wake word in subsequently captured ambient audio signals. However, when the electronic computing device detects the wake word in the captured audio signals (e.g., by matching the captured audio signals to one or more wake word voice control tokens in the voice control dictionaries), then the electronic computing device further processes the audio signals captured immediately after the wake word to identify any voice commands in the audio signals (e.g., by matching the captured audio signals to one or more voice command tokens in the voice control dictionaries) and provide an appropriate response corresponding to any identified voice command.

Turning now to FIG. 3 a flowchart diagram illustrates a process 300 for modifying the functionality of an electronic computing device to prevent an electronic digital assistant from processing sensitive voice commands when the computing device is in the presence of an unauthorized user. While a particular order of processing steps, message receptions, and/or message transmissions is indicated in FIG. 3 for exemplary purposes, timing and ordering of such steps, receptions, and transmissions may vary where appropriate without negating the purpose and advantages of the examples set forth in detail throughout the remainder of this disclosure.

Process 300 begins at block 302 where the electronic computing device provides an electronic digital assistant configured to receive a set of voice commands. The electronic digital assistant may be implemented as the electronic digital assistant described above and may include any of the functionalities or other implementation details described above.

At block 304, the electronic computing device receives, from at least one occupancy sensor, data indicating an occupancy status of one or more seating zones of the vehicle 132. The at least one occupancy sensor may be implemented as any of the occupancy sensors described above, which may include, for instance, at least one pressure sensor, mmWave sensor, IR sensor, or camera.

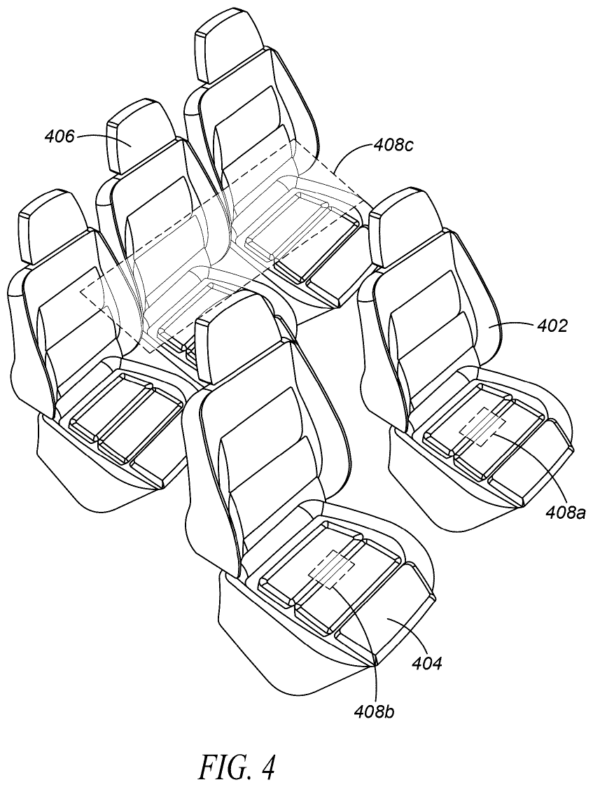

Example seating zones of the vehicle 132 are depicted in FIG. 4. As shown, the vehicle 132 may be provisioned with one or more seats, which may include a driver seat 402, a front passenger seat 404, and one or more rear passenger seats 406. The electronic computing device may define one or more seating zones 408 corresponding to the seats of the vehicle 132. For instance, the seating zones 408 may include a first seating zone 408a corresponding to the driver seat 402, a second seating zone 408b corresponding to the front passenger seat 404, and a third seating zone 408c corresponding to the rear passenger seats 406. The electronic computing device may define these seating zones 408 by storing respective identifiers of the zones 408 in the static memory 216. Further, the electronic computing device may establish logical relationships between the identifiers of the zones 408 and identifiers of any occupancy sensors configured to detect occupancy statuses of the zones. For instance, the vehicle 132 may include a first occupancy sensor implemented as a pressure sensor installed in a base of the driver seat 402, a second occupancy sensor implemented as a pressure sensor installed in a base of the front passenger seat 404, and a third occupancy sensor implemented as a mmWave sensor having a sensing FOV that extends across all of the rear passenger seats 406. In such an example, the electronic computing device may store the identifier of the first seating zone 408a in association with an identifier of the first occupancy sensor, the identifier of the second seating zone 408b in association with an identifier of the second occupancy sensor, and the identifier of the third seating zone 408c in association with an identifier of the third occupancy sensor. In this manner, when the electronic computing device receives data from an occupancy sensor indicating an occupancy status, the electronic computing device may determine which of the seating zones 408 the occupancy status reflects based on the identifier of the occupancy sensor.

At block 306, the electronic computing device determines that a particular seating zone from among the seating zones 408 is occupied. Continuing the example above, for instance, the electronic computing device may receive sensor data from the first, second, and third occupancy sensors indicating respective occupancy statuses of the first seating zone 408a, second seating zone 408b, and third seating zone 408c. A driver may be seated in the driver seat 402, and so the first occupancy sensor provides data to the electronic computing device indicating that the first seating zone 408a is occupied. The front passenger seat 404 may be vacant, and so the second occupancy sensor provides data to the electronic computing device indicating that the second seating zone 408b is unoccupied. Finally, a passenger may be seated in the rear passenger seat 406, and so the third occupancy sensor provides data to the electronic computing device indicating that the third seating zone 408c is occupied.

As will be explained in further detail below, when making the determination at block 306, the electronic computing device may be configured to perform certain functionalities based on which one or ones of the different seating zones 408 are occupied.

At block 308, in response to determining that the particular seating zone from among the seating zones 408 is occupied, the electronic computing device modifies the functionality of the electronic digital assistant by disabling one or more of the voice commands the electronic digital assistant is configured to receive and/or by disabling one or more wake words for activating the electronic digital assistant.

One way to modify the electronic digital assistant in this manner is by way of the one or more voice control dictionaries, which, as described above, may be stored in the static memory 216 and used by the electronic digital assistant to identify and perform voice control tasks.

FIG. 5 illustrates examples of such voice control dictionaries, including a wake word dictionary 500 and a voice command dictionary 502. The wake word dictionary 500 may include wake word data 504 for each of the wake words the electronic digital assistant is configured to receive, and the voice command dictionary 502 may similarly include voice command data 506 for each of the voice commands the electronic digital assistant is configured to receive. In line with the discussion above, the wake word data 504 and the voice command data 506 may include audio or voice tokens that the electronic digital assistance may use to determine when one of the wake words or voice commands is uttered in the vicinity of the electronic computing device. While the wake word dictionary 500 depicts wake word data 504 for an M number of wake words, and the voice command dictionary 502 depicts voice command data 506 for an N number of voice commands, it should be understood that such dictionaries may include wake word data 504 and voice command data 506 for any suitable number of wake words or voice commands.

As further shown, the wake word dictionary 500 and the voice command dictionary 502 may further include data for flagging an enabled status 508 of the wake words and voice commands. This enabled status data 508 may indicate whether a given wake word or voice command is enabled or disabled. For example, as depicted, the enabled status data 508 can be represented as a “Y” for an enabled wake word or voice command and an “N” for a disabled wake word or voice command. However, any other suitable data format may be used as well.

The electronic digital assistant may use the enabled status data 508 when “listening” for wake words and voice commands and for determining whether to perform respective tasks associated with the wake words and voice commands. In some examples, for instance, the electronic digital assistant may ignore disabled wake words and voice commands (i.e., the wake words and voice commands for which the enabled status data 508 indicates a disabled status). That is, when “listening” for wake words and voice commands uttered in the vicinity of the electronic computing device, the electronic digital assistant may refrain from attempting to identify the utterance of the disabled wake words and voice commands, such as by refraining from comparing any audio or voice tokens associated with the disabled wake words and voice commands to any captured ambient audio signals. In other examples, the electronic digital assistant may continue to “listen” for the disabled wake words and voice commands, and when one of the disabled wake words or voice commands is detected, the electronic digital assistant may refrain from performing a task associated with the detected wake word or voice command. Instead, the electronic digital assistant may cause the electronic computing device to output a notification that a disabled wake word or voice command was detected, such as in the form of an audio and/or visual notification.

Conditioning the functionality of the electronic digital assistant on the enabled status data 508 in the above-described manner allows the electronic computing device to disable one or more voice commands or wake words at block 308 by toggling the enabled status data 508 for the one or more voice commands or wake words from an enabled status to a disabled status. However, this is merely one illustrative example for disabling voice commands and wake words and any other suitable disabling techniques may be applied in other example arrangements.

When disabling the one or more voice commands or wake words at block 308, the electronic computing device may apply various different techniques for selecting which voice commands or wake words to disable. In line with the discussion above, a goal of the present disclosure is to prevent unauthorized users from causing the electronic digital assistant to perform certain tasks that are better initiated by an authorized user, referred to herein as “sensitive” tasks.

Accordingly, in some examples, and as depicted in FIG. 5, the voice command dictionary 502 may further include sensitive status data 510 indicating whether each voice command in the dictionary 502 is associated with such a sensitive task. For instance, in line with the discussion above, the electronic digital assistant may be configured to interface with a public safety computing system, such that examples of sensitive voice commands may include voice commands that cause the electronic computing device to control other electronic computing devices or to transmit or receive information to or from other electronic computing devices. Examples of such sensitive voice commands may include a status query for an active public safety incident, a status query for a public safety officer, a command for accessing a radio transmission/reception feature of the electronic computing device (e.g., sending a radio signal to another electronic computing device or changing a radio channel to which the electronic computing device is subscribed), or a command for accessing a dispatch feature of the public safety computing system (e.g., a request to dispatch public safety officers to a particular location). Examples of non-sensitive voice commands, on the other hand, may include voice commands for tasks that only affect a local operation of the electronic computing device and that do not affect the operation of other electronic computing devices, such as tasks affecting an operational mode of the electronic device (e.g., a volume change or the like). However, it should be understood that these examples of sensitive and non-sensitive commands are merely illustrative, and other examples of sensitive commands may be applicable in different arrangements.

Further, in some examples, the electronic digital assistant may be configured to employ different functionalities depending on the wake word used to activate the assistant. For instance, in some examples, the electronic digital assistant may be configured to perform sensitive tasks, such as those described above, only when a particular wake word is used to activate the assistant and not when another wake word is used to activate the assistant. In this manner, certain wake words may be similarly identified as sensitive wake words, such that the wake word dictionary 500 may similarly include the sensitive status data 510 indicating which of the wake words are sensitive and which are non-sensitive.

With this arrangement, when disabling the one or more voice commands or wake words at block 308, the electronic computing device may disable only those voice commands or wake words identified as sensitive by the sensitive status data 510. The sensitive status data 510 may be predefined data specified by user input. Additionally or alternatively, the sensitive status data 510 may be determined by the electronic computing device. For instance, the electronic computing device may identify a task corresponding to a particular voice command and determine, based on the nature of the task, whether the voice command is a sensitive command. As one example, the electronic computing device may determine that a task involves transmitting or receiving data to or from another electronic computing device and, based on that determination, sets the sensitive status data 510 for that voice command to a sensitive status. As another example, the electronic computing device may determine that a task does not involve transmitting or receiving data to or from another electronic computing device and, based on that determination, sets the sensitive status data 510 for that voice command to a non-sensitive status. Other examples are possible as well.

While not depicted in FIG. 3, the process 300 may further include additional steps for re-enabling the disabled one or more voice commands or wake words. For instance, the electronic computing device may continue to receive sensor data from the occupancy sensors and determine, based on the sensor data, that the particular seating zone is no longer occupied. In response to making this determination, the electronic computing device may enable the one or more voice commands or wake words that were disabled at block 308. Enabling the one or more voice commands or wake words may involve toggling the enabled status data 508 for the one or more voice commands or wake words from a disabled status to an enabled status.

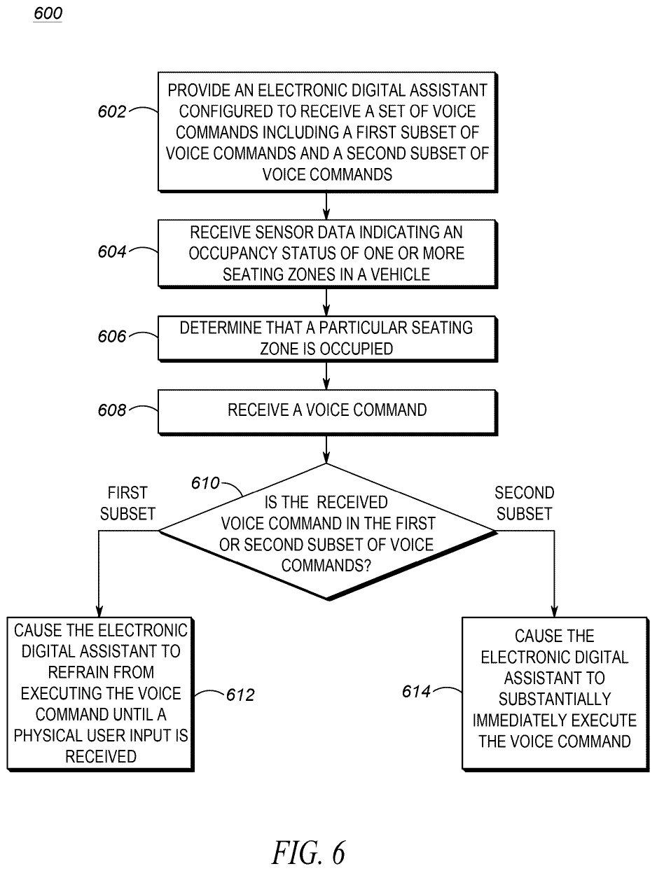

Turning next to FIG. 6, a flowchart diagram illustrates another process 600 for modifying the functionality of an electronic computing device to prevent an electronic digital assistant from processing sensitive voice commands when the computing device is in the presence of an unauthorized user. While a particular order of processing steps, message receptions, and/or message transmissions is indicated in FIG. 6 for exemplary purposes, timing and ordering of such steps, receptions, and transmissions may vary where appropriate without negating the purpose and advantages of the examples set forth in detail throughout the remainder of this disclosure.

Process 600 begins at block 602 where the electronic computing device provides an electronic digital assistant configured to receive a set of voice commands. The electronic digital assistant may be implemented as the electronic digital assistant described above and may include any of the functionalities or other implementation details described above. Further, the set of voice commands includes a first subset of voice commands and a second subset of voice commands. The first subset of voice commands may correspond to the sensitive voice commands described above, while the second subset of voice commands may correspond to the non-sensitive voice commands described above, and these first and second subsets may be distinguished from one another by the sensitive status data 510 in the manner described above.

At block 604, the electronic computing device receives, from at least one occupancy sensor, data indicating an occupancy status of one or more seating zones of the vehicle 132. And at block 606, the electronic computing device determines that a particular seating zone from among the seating zones 408 is occupied. Blocks 604 and 606 correspond to blocks 304 and 306 of process 300 of FIG. 3 and may involve any of the functionalities described above in connection with those blocks.

At block 608, the electronic computing device receives a voice command. In line with the discussion above, the voice command may be uttered by an individual in the vicinity of the electronic computing device, and the electronic computing device may receive the voice command by capturing ambient audio signals using the microphone 220.

In response to both receiving the voice command at block 608 and determining that the particular seating zone is occupied at block 606, the electronic computing device performs a voice command verification process in order to verify that the received voice command was uttered by an authorized user or is otherwise approved by an authorized user. Such a voice command verification process is represented by blocks 610, 612, and 614.

At block 610, the electronic computing device determines whether the received voice command is in the first subset of voice commands or the second subset of voice commands. The electronic computing device may use the voice control dictionaries to make this determination. For instance, in line with the discussion above, the electronic digital assistant may compare the captured audio signals containing the voice command to audio or voice tokens stored in the voice command dictionary 502 in order to match the received voice command to one of the voice commands in the dictionary 502. The electronic digital assistant may further determine whether the matching voice command in the dictionary 502 is in the first or second subset of voice commands based on the sensitive status data 510 associated with the matching voice command. If the sensitive status data 510 indicates that the matching voice command is a sensitive voice command, then the electronic digital assistant determines that the received voice command is in the first subset of voice commands. If the sensitive status data 510 indicates that the matching voice command is a non-sensitive voice command, then the electronic digital assistant determines that the received voice command is in the second subset of voice commands.

When the electronic digital assistant determines that the received voice command is in the first subset of voice commands (e.g., when the received voice command is a sensitive voice command), then the process 600 advances to block 612.

At block 612, the electronic computing device causes the electronic digital assistant to temporarily refrain from executing the voice command while the electronic computing device attempts to authorize the voice command by way of receiving a physical user input. This may involve the electronic computing device sending a pause instruction to the electronic digital assistant thereby causing the assistant to take no further action in connection with the voice command until further instruction from the electronic computing device. Concurrently or sequentially, the electronic computing device may also output an audio and/or visual prompt requesting the physical user input.

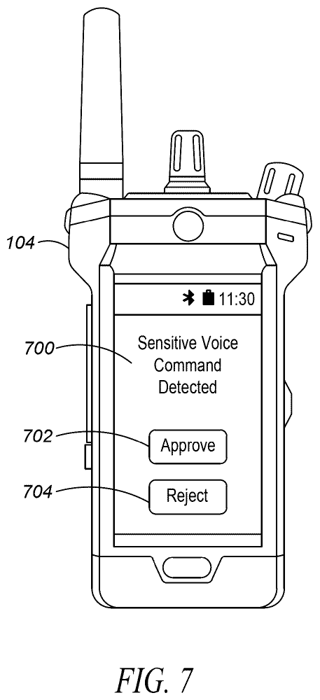

FIG. 7 illustrates an example of a user interface 700 for outputting such a prompt for requesting authorization of the voice command. As shown, the interface 700 includes a visual indication that the received voice command has been identified as a sensitive voice command as well as selectable buttons for specifying whether the sensitive voice command is authorized for execution. Namely, the interface 700 includes an approve button 702 and a reject button 704. When the electronic computing device receives a physical user input corresponding to a selection of the approve button 702, the electronic computing device instructs the electronic digital assistant to resume the temporarily paused execution of the voice command. In line with the discussion above, this may involve determining a task or response corresponding to the voice command (e.g., using the voice control dictionaries in the static memory 216 or the database(s) 164) and causing the electronic computing device to perform the task or output the response. When the electronic computing device receives a physical user input corresponding to a selection of the reject button 704, the electronic computing device instructs the electronic digital assistant to discard the voice command by refraining from any further execution of the voice command. Additionally or alternatively, the electronic computing device may associate a timer with the prompt and, if the electronic computing device fails to receive a selection of the approve button 702 or the reject button 704 before expiration of the timer, then the electronic computing device may similarly instruct the electronic digital assistant to discard the voice command by refraining from any further execution of the voice command.

While FIG. 7 depicts the electronic computing device as the portable radio 104 of FIG. 1 and the interface 700 as a touchscreen display of the portable radio 104, it should be understood that any other suitable implementations are considered herein as well. For instance, in some examples, the electronic computing device may be implemented as the mobile communication device 133 of the vehicle 132, which may include an in-vehicle radio system (e.g., an APX® P25 Mobile Radio provided by Motorola Solutions, Inc.), and the interface 700 may be provided by way of a touchscreen display of the mobile communication device 133. Further, in some examples, the interface 700 may not be limited to a touchscreen display, but may include or otherwise be implemented as an analog button, which may be a dedicated button or a multipurpose button for receiving the physical input for approving authorization of the voice command. Such a button may be implemented in a manner that allows a driver to provide the physical input without significantly distracting the driver from the road. For instance, in some examples, the button may be implemented as a foot switch communicatively coupled to the processor(s) 213 of the electronic computing device and arranged in a footwell of the vehicle 132 (e.g., near an accelerator or brake pedal of the vehicle 132). In such an arrangement, the driver may provide the physical user input without diverting their eyes from the road by using their foot to physically actuate the foot switch.

Returning to the process 600, when the electronic digital assistant determines at block 610 that the received voice command is in the second subset of voice commands (e.g., when the received voice command is a non-sensitive voice command), then the process 600 advances to block 614.

At block 614, because the voice command is a non-sensitive voice command for which no authentication is desired, the electronic computing device causes the electronic digital assistant to substantially immediately execute the voice command. As used herein, the term “substantially immediately” refers to the amount of time that is required for the electronic digital assistant to process and execute the voice command as it would during its normal operation of processing and executing voice commands without engaging in any of the additional authentication steps described above at block 612. In this manner, executing the voice command “substantially immediately” may include the amount of time the electronic digital assistant requires to determine the task or response corresponding to the voice command and cause the electronic computing device to perform the task or output the response.

In line with the discussion above, the process 300 depicted in FIG. 3 and the process 600 depicted in FIG. 6 may be particularly advantageous in public safety scenarios where an unauthorized individual is capable of uttering voice commands in the vicinity of a public safety electronic computing device, such as when a public safety officer is sitting in the driver seat 402 of the vehicle 132 with a detainee or arrestee sitting in a passenger seat (e.g., the front passenger seat 404 or the rear passenger seat 406) of the vehicle 132. Accordingly, in some examples, the step of determining that the particular seating zone is occupied at block 306 and at block 606 may involve determining that a passenger seating zone is occupied (e.g., the second seating zone 408b or the third seating zone 408c). Further, because detainees or arrestees are typically seated in the rear passenger seat 406, the particular seating zone may be limited to rear passenger seating zones (e.g., the third seating zone 408c) in some examples.

Further, in some examples, the processes depicted in FIGS. 3 and 6 may further include steps for automatically defining the seating zones, which may include steps for specifying which particular seating zone(s) are monitored for occupancy at blocks 306 and 606. For instance, the electronic computing device may have stored configuration data in the static memory 216 that identifies different seating configurations and/or occupancy sensor configurations for different types of vehicles. This configuration data may include data indicating a number of seats in the vehicle 132 and their relative positions in the vehicle 132, as well as a number of occupancy sensors in the vehicle 132 and their positions relative to the vehicle seats. In this manner, the electronic computing device may receive or otherwise be provisioned with vehicle data indicating a type of the vehicle 132 and may reference the configuration data to determine the seating configuration and/or occupancy sensor configuration of the vehicle 132 based on the indicated vehicle type.

The data indicating the type of the vehicle 132 may take various forms and may include, for instance, a make, model, and/or year of the vehicle 132. In some examples, this data may further include information identifying a modified configuration of the vehicle 132. For example, some public safety vehicles may have a “prisoner configuration” in which the vehicle 132 includes a physical partition, such as a metallic mesh or polycarbonate window, separating a rear seating area of the vehicle from a front seating area of the vehicle for the safety of the officer. As such, the data indicating the type of the vehicle 132 may indicate whether the vehicle 132 is in the prisoner configuration or in some other configuration.

Upon determining the type of the vehicle 132, the seating configuration, the occupancy sensor configuration, and/or any other operational configurations of the vehicle 132, such as the prisoner configuration, the electronic computing device may use this information as a basis for defining the one or more seating zones.

Referring back to FIG. 4 as an example, the electronic computing device may receive data indicating that the vehicle 132 is a 2024 Ford Explorer. By referencing the vehicle configuration data stored in the static memory 216, the electronic computing device may determine that a 2024 Ford Explorer includes the driver seat 402 and the front passenger seat 404 in a front seating area of the vehicle 132 and the rear passenger seat 406 in a three-seat bench configuration in a rear seating area of the vehicle 132. The vehicle configuration data may further indicate to the electronic computing device that the vehicle 132 includes a first occupancy sensor implemented as a pressure sensor in the driver seat 402 and a second occupancy sensor implemented as a pressure sensor in the front passenger seat 404. Still further, the electronic computing device may receive data indicating that the vehicle 132 is in a prisoner configuration, and the vehicle configuration data may indicate to the electronic computing device that because the vehicle 132 is in the prisoner configuration it further includes a third occupancy sensor implemented as a mmWave sensor in the rear seating area of the vehicle 132.

With this information, the electronic computing device may define the different seating zones of the vehicle 132 by creating data objects representing each zone and associating the data objects with the appropriate occupancy sensor outputs. For instance, the electronic computing device may create a first data object representing the first seating zone 408a and may associate the sensor output of the pressure sensor in the driver seat 402 with the first data object. Similarly, the electronic computing device may create a second data object representing the second seating zone 408b and may associate the sensor output of the pressure sensor in the front passenger seat 404 with the second data object. And the electronic computing device may create a third data object representing the third seating zone 408c and may associate the sensor output of the mmWave sensor in the rear seating area with the third data object.

Further, when defining the seating zones of the vehicle 132, the electronic computing device may define which particular one(s) of the seating zones are monitored for occupancy at blocks 306 and 606, and the electronic computing device may use the data indicating the type of the vehicle 132 to do so. For instance, vehicles in the prisoner configuration may have an increased likelihood of having unauthorized users (e.g., detainees or arrestees) in the rear passenger seat 406. Thus, based on receiving data indicating that the vehicle 132 has the prisoner configuration, the electronic computing device may select the third seating zone 408c as the particular seating zone that is monitored for occupancy at blocks 306 and 606 (which may also include selecting the third seating zone 408c as one of multiple particular seating zones that are monitored for occupancy at blocks 306 and 606). However, the electronic computing device may select different one(s) of the seating zones to monitor for occupancy at blocks 306 and 606 based on different vehicle data in other examples.

When performing either of the processes depicted in FIGS. 3 and 6 it should be understood that the electronic computing device may be implemented in a distributed manner in that it may include multiple electronic processors distributed remotely from each other and performing different aspects of the processes. In some examples of process 600, for instance, the electronic processor 213 of the portable radio 104 may perform the electronic digital assistant functions while the electronic processor 213 of the mobile communication device 133 performs the voice command authentication functions (e.g., outputting the prompt for the physical user input and receiving the input), or vice versa. Any other suitable distribution of the processes across the portable radio 104 and the mobile communication device 133 are also considered herein.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various examples may be written in an object oriented programming language such as Java, Smalltalk, C++, Python, or the like. However, the computer program code for carrying out operations of various examples may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A system comprising:
an electronic computing device comprising (i) a user interface for receiving a physical user input and (ii) an electronic digital assistant configured to receive a set of voice commands, the set of voice commands comprising a first subset of voice commands and a second subset of voice commands;
at least one occupancy sensor configured to output sensor data indicating an occupancy status of one or more seating zones in a vehicle;
at least one processor; and
non-transitory, computer-readable data storage comprising program instructions that, when executed by the at least one processor, cause performance of a set of operations comprising:
receiving, by the electronic computing device, a voice command;
determining whether the received voice command is included in the first subset of voice commands or the second subset of voice commands;
determining, based on the sensor data, that a particular seating zone of the one or more seating zones in the vehicle is occupied; and
in response to both receiving the voice command and determining that the particular seating zone is occupied, performing a voice command verification process comprising:
(i) when the received voice command is included in the first subset of voice commands, causing the electronic digital assistant to refrain from executing the voice command until the user interface of the electronic computing device receives the physical user input; and
(ii) when the received voice command is included in the second subset of voice commands, causing the electronic digital assistant to substantially immediately execute the voice command.

2. The system of claim 1, wherein the electronic computing device comprises at least one of a portable radio or a mobile communication device integrated into the vehicle.

3. The system of claim 2, wherein the electronic computing device comprises both the portable radio and the mobile communication device integrated into the vehicle, wherein the portable radio comprises the user interface for receiving the physical user input, and wherein the mobile communication device integrated into the vehicle comprises the electronic digital assistant.

4. The system of claim 1, wherein the set of voice commands comprises voice commands for interfacing with a public safety computing system, and wherein the first subset of voice commands comprises at least one of (i) an incident status query, (ii) an officer status query, (iii) a radio access command, or (iv) a dispatcher access command.

5. The system of claim 1, wherein the user interface comprises a foot switch arranged in a footwell of the vehicle, and wherein the physical user input comprises an actuation of the foot switch.

6. The system of claim 1, wherein the particular seating zone comprises a rear seating zone located in a rear seating area of the vehicle.

7. The system of claim 1, the set of operations further comprising:
receiving vehicle data indicating a type of the vehicle; and
defining the one or more seating zones based on the type of the vehicle.

8. The system of claim 7, the set of operations further comprising:
determining a seating configuration of the vehicle based on the type of the vehicle, wherein defining the one or more seating zones based on the type of the vehicle comprises defining the one or more seating zones based on the determined seating configuration of the vehicle.

9. The system of claim 7, wherein the vehicle data indicates that the type of the vehicle is that of a vehicle comprising a physical barrier separating a rear seating area of the vehicle from a front seating area of the vehicle, and wherein defining the one or more seating zones based on the type of the vehicle comprises defining the one or more seating zones to include at least a portion of the rear seating area based on the vehicle comprising the physical barrier.

10. A method comprising:
providing (i) a user interface for receiving a physical user input and (ii) an electronic digital assistant configured to receive a set of voice commands, the set of voice commands comprising a first subset of voice commands and a second subset of voice commands;
receiving, by the electronic digital assistant, a voice command;
determining, by the electronic digital assistant, whether the received voice command is included in the first subset of voice commands or the second subset of voice commands;
receiving, from at least one occupancy sensor, sensor data indicating an occupancy status of one or more seating zones in a vehicle;
determining, based on the sensor data, that a particular seating zone of the one or more seating zones in the vehicle is occupied; and
in response to both receiving the voice command and determining that the particular seating zone is occupied, performing a voice command verification process comprising:
(i) when the received voice command is included in the first subset of voice commands, causing the electronic digital assistant to refrain from executing the voice command until the user interface receives the physical user input; and
(ii) when the received voice command is included in the second subset of voice commands, causing the electronic digital assistant to substantially immediately execute the voice command.

11. The method of claim 10, wherein the set of voice commands comprises voice commands for interfacing with a public safety computing system, and wherein the first subset of voice commands comprises at least one of (i) an incident status query, (ii) an officer status query, (iii) a radio access command, or (iv) a dispatcher access command.

12. The method of claim 10, wherein the user interface comprises a foot switch arranged in a footwell of the vehicle, and wherein the physical user input comprises an actuation of the foot switch.

13. The method of claim 10, wherein the particular seating zone comprises a rear seating zone located in a rear seating area of the vehicle.

14. The method of claim 10, the further comprising:
receiving vehicle data indicating a type of the vehicle; and
defining the one or more seating zones based on the type of the vehicle.

15. The method of claim 14, wherein the vehicle data indicates that the type of the vehicle is that of a vehicle comprising a physical barrier separating a rear seating area of the vehicle from a front seating area of the vehicle, and wherein defining the one or more seating zones based on the type of the vehicle comprises defining the one or more seating zones to include at least a portion of the rear seating area based on the vehicle comprising the physical barrier.

16. An electronic computing device comprising:
a user interface for receiving a physical user input;
an electronic digital assistant configured to receive a set of voice commands, the set of voice commands comprising a first subset of voice commands and a second subset of voice commands;
at least one processor; and
non-transitory, computer-readable data storage comprising program instructions that, when executed by the at least one processor, cause performance of a set of operations comprising:
receiving, by the electronic digital assistant, a voice command;
determining, by the electronic digital assistant, whether the received voice command is included in the first subset of voice commands or the second subset of voice commands;
receiving, from at least one occupancy sensor, sensor data indicating an occupancy status of one or more seating zones in a vehicle;
determining, based on the sensor data, that a particular seating zone of the one or more seating zones in the vehicle is occupied; and
in response to both receiving the voice command and determining that the particular seating zone is occupied, performing a voice command verification process comprising:
(i) when the received voice command is included in the first subset of voice commands, causing the electronic digital assistant to refrain from executing the voice command until the user interface receives the physical user input; and
(ii) when the received voice command is included in the second subset of voice commands, causing the electronic digital assistant to substantially immediately execute the voice command.

17. The electronic computing device of claim 16, wherein the set of voice commands comprises voice commands for interfacing with a public safety computing system, and wherein the first subset of voice commands comprises at least one of (i) an incident status query, (ii) an officer status query, (iii) a radio access command, or (iv) a dispatcher access command.

18. The electronic computing device of claim 16, wherein the user interface comprises a foot switch arranged in a footwell of the vehicle, and wherein the physical user input comprises an actuation of the foot switch.

19. The electronic computing device of claim 16, wherein the particular seating zone comprises a rear seating zone located in a rear seating area of the vehicle.

20. The electronic computing device of claim 16, the set of operations further comprising:
receiving vehicle data indicating a type of the vehicle, wherein the vehicle data indicates that the type of the vehicle is that of a vehicle comprising a physical barrier separating a rear seating area of the vehicle from a front seating area of the vehicle; and
defining the one or more seating zones based on the type of the vehicle, wherein defining the one or more seating zones based on the type of the vehicle comprises defining the one or more seating zones to include at least a portion of the rear seating area based on the vehicle comprising the physical barrier.
